(19) United States
(12) Patent Application Publication
(10) Pub. No.: US 2017/0371842 A1
(43) Pub. Date: Dec. 28, 2017

(54) SUPPRESSING PREVIOUSLY CONSUMED CONTENT ITEMS OF A WEBSITE

(71) Applicant: INTERNATIONAL BUSINESS MACHINES CORPORATION, Armonk, NY (US)

(72) Inventors: JONATHAN F. BRUNN, LOGAN, UT (US); JEFFREY R. HOY, GIBSONIA, PA (US); MARIT L. IMSDAHL, MORRISVILLE, NC (US); ASIMA SILVA, HOLDEN, MA (US)

(21) Appl. No.: 15/190,375

(22) Filed: Jun. 23, 2016

(51) Int. Cl. G06F 17/21; H04L 29/08; G06F 3/0484

(52) U.S. Cl. CPC G06F 17/212; G06F 3/0484; H04L 67/02

(57) ABSTRACT

A browser renders web site views dynamically, based on previously consumed content items. When the browser loads a new web site which contains, among other object, content items, those content items which are duplicative of previously consumed content items are suppressed when the web site view is rendered in the browser. Content items that are related to previously consumed content items can be prioritized in the rendered view of the web site.

### BACKGROUND

The present invention relates generally to web browsing, and more particularly to browsing multiple content sites which include content that is found on other content sites browsed by a user who does not wish to see duplicate content items.

Web browsing is a common means for people to consume media today, with many content providers publishing media on a variety of content servers. In addition, media can be made available through media aggregator sites by linking to media content sites. While browsing on various websites a user may encounter the same or similar content items (e.g. articles, documents, or other media). A user can chose to consume a content item by clicking on a link, which can be in the form of an anchor that includes text and/or an image. Upon clicking on the link the user's machine will then load and display the content item to the user. The display of the content item is controlled by, for example, a hyper-text markup language (HTML), which can be used to generate or form a document object model (DOM) of the content. The DOM allows the client machine to display the content item as a dynamic and interactive page.

Upon further browsing activity, the user may encounter the consumed content on other sites. For example, a user can browse a news site and read articles hosted by the news site. Then while browsing a social media site, the user may encounter the same previously read content in posts by other users of the social media site which are provided to the user as a feed based on the user's social connections. While the user may not want to see duplication of content already viewed, he or she may wish to see related content. However, presently there is no known browsing system that presently suppresses already consumed content while prioritizing content related to the already consumed content across multiple media providing web sites.

### BRIEF SUMMARY

According to some embodiments of the inventive teachings, a method for a client machine to control display of content across a plurality of media source web sites includes determining consumed content items provided by the media source web sites which are consumed by a user of the client machine during interactions with the plurality of media source web sites. The method further includes creating a record of consumed content items. Upon the user interacting with a further media source web site, the method further includes determining duplicative content items of the further media source web site that are similar to the consumed content items based on the record of consumed content items. The method further includes suppressing the duplicative content items from being displayed to the user while interacting with the further media web site, and identifying a related content item of the further media source site that is related to one of the consumed content items The method further includes prioritizing the related content item for display to the user during interaction with the further media source site.

According to other embodiments a method for controlling display of content that is duplicated on different sources includes determining, at a client machine, content items a user of the client machine has consumed from at least one web site and maintaining a record of consumed content items responsive to determining content items consumed by the user. The method further includes receiving an input from the user of the client machine to navigate a content web site containing content items or links to content items, and loading the content web site at the client machine while identifying content items of the content web site that are duplicative of content items already consumed by the user as indicated in the record of consumed content items. The method further includes suppressing, at the client machine, display of content items of the content web site that are duplicative of consumed content as indicated by the record of consumed content items while loading the content web site, and identifying a related content item of the content web site that is related to at least one of the consumed content items. The method further includes prioritizing the related content item for display in loading the content web site.

According to further embodiments a computer program product is a non-transitory computer readable storage medium on which computer code is stored. The code stored thereon includes computer code which when executed by a computing device causes the computing device to determine content items a user of the computing has consumed from at least one web site and maintain a record of consumed content items responsive to determining content items consumed by the user. The code stored on the storage medium further includes code that causes the computing device to receive an input from the user of the computing device to navigate a content web site containing content items or links to content items and to load the content web site at the computing device while identifying content items of the content web site that are duplicative of content items already consumed by the user as indicated in the record of consumed content items. The storage medium further includes code that causes the computing device to suppress display of content items of the content web site that are duplicative of consumed content as indicated by the record of consumed content items while loading the content web site, and to identify a related content item of the content web site that is related to at least one of the consumed content items. The storage medium further includes code that causes the computing device to prioritize the related content item for display in loading the content web site.

### BRIEF DESCRIPTION OF THE SEVERAL VIEWS OF THE DRAWINGS

FIG. 1 is a system diagram showing a client machine that interacts with several web sites that each provide various media content items, in accordance with some embodiments;

FIG. 2 is a flowchart diagram of a method for suppressing content items previously consumed by a user, and prioritizing related content items when navigating to a new web site, in accordance with some embodiments;

FIG. 3 is a flow chart diagram of a method for determining when a user has consumed a content item at a client machine, in accordance with some embodiments;

FIG. 4 is a flow chart diagram of a method for suppressing content items previously consumed by a user, and prioritizing related content items when navigating to a new web site, in accordance with some embodiments;

FIG. 5 is a flow chart diagram of a method for suppressing content items previously consumed by a user, and prioritizing related content items when navigating to a new web site, in accordance with some embodiments; and

FIG. 6 shows a display of a window by a computing device in which a previously consumed content item is suppressed and a content item related to a previously consumed content item is prioritized, in accordance with some embodiments.

### DETAILED DESCRIPTION

The present invention relates to the viewing of web sites at a client machine, where the web sites viewed often include common content. This is particularly applicable to social media web sites where different users often post, re-post, and share content hosted on other web sites. As a user navigates to different web sites, content items or objects are rendered for viewing and interaction in a browser. As these content items are loaded, they are identified and a record of content items that are “consumed” by the user is maintained. When the user navigates to a new web site that contains duplicative content items (i.e. content items already consumed by the user), these duplicative content items are suppressed in the rendered view of the web site. Furthermore, content items that are related to previously consumed content items (which have not themselves previously been consumed by the user) can be identified and prioritized in the rendered view of the web site.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

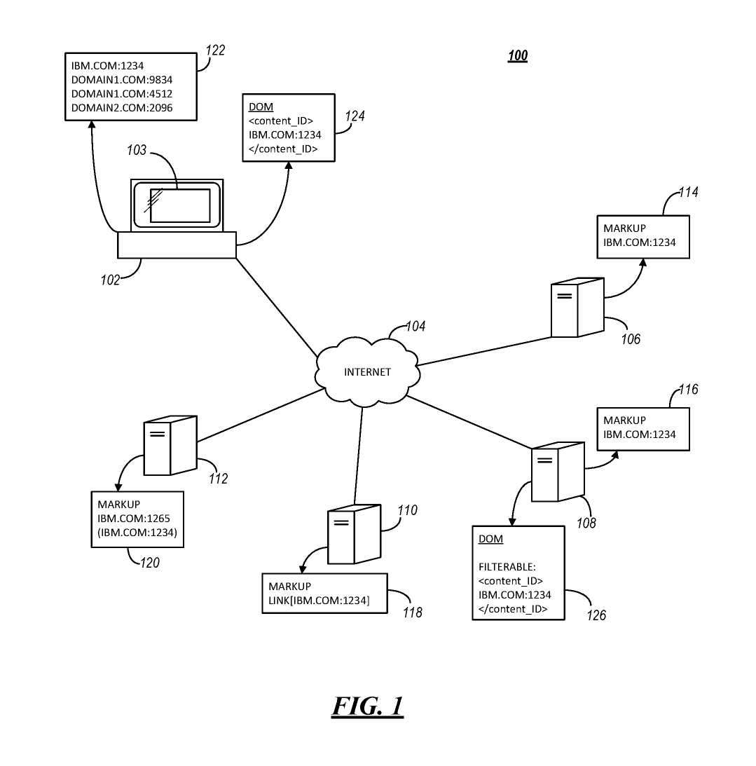

FIG. 1 is a system diagram of a system 100 including a client machine 102 that interacts with several web sites that each provide various media content items, in accordance with some embodiments. The client machine 102 can be any of several types of computing devices such as a desktop or laptop computer, smartphone or tablet device, etc. These devices are used by people to access various web sites via the Internet 104 using a browser 103. Browsers are applications programs that work with the computing device's networking resources to connect with remotely located web site servers that provide code (e.g. markup) and data to render a view of the web site content in a browser window (e.g. 103) on a display of the computing device 102. As a result, the user of the computing device can view and interact with the web site content rendered by the browser 103. Many browsers now allow third party software programs such as plug-ins that can inter-operate with the browser to augment or change how the browser presents content. For example, browser plug-ins that block advertisements on web sites from being displayed are common.

The system 100 includes several web sites 106, 108, 110, 112 that are abstractly represented as servers, with which the computing device 102 can communicate via the Internet 104 and associated network connections. Each web site 106-112 serves content items 114, 116, 118, 120, respectively. The web sites 106-112 can be social media web sites, news web sites, or other web sites that provide, essentially, a feed of information, meaning new content items are published and presented on these web sites 106-112 from time to time. It is known, particularly on social media web sites, that content items like links to news articles on news web sites get are posted and reposted. In general, web sites respond to access requests with code that can include markup, text, and uniform resource locators (URLs) for media and graphics. The code can be in the form of a document, or a document object model (DOM), and can represent content items. For example, web sites 106-112 can provide content items 114, 116, 118, 120, respectively, which can be in the form of HTML documents that each include a content identifier to uniquely identify the content item. The content items can be news articles or other writings, media pages with video and/or audio media, and so on. The identifier in each content item 114-120 can include a name space, such as a domain name, and a serial number, having a form such as “ibm.com:1234,” where “ibm.com” is the domain name and “1234” is the serial number.

As an example, assume the browser 103 of the computing device 102 is navigated to web site 106 to load content item 114. The web site 106 responds by transmitting the data for the content item 114 and associated code for rendering the content item 114 in the browser 103. Rendering the content item refers to presenting it in the browser 103 so that it can be perceived, and interacted with if designed to be interactive, by a user of the computing device 102. The browser, or software associated with the browser 103, can build a DOM 124 of the content item 114 locally at the computing device. The identifier of the content item 114, “ibm.com:1234,” is then saved in a content record 122 maintained at the computing device 102. The content record 122 can include a list of content item identifiers, if they are included with the content item. In some embodiments, where a standardized content identifier is not present with the content item, the browser 103, or a browser agent (e.g. a browser plug-in application) can process a portion of the content item to produce an identifying primitive data structure, such as by identifying keywords using semantic language processing. The identifying primitive can then be stored in the content record 122 to later identify the same content being provided by other web sites or in other feeds on the same website.

After the computing device 102, has loaded and rendered content item 114, the user of the computing device 102 can navigate, for example, to web site 108, which can include a duplicate content item 116 which is a substantial duplicate of content item 114 on web site 106. The duplicate content item 116 can include the content identifier (e.g. “imb.com:1234”) in association with the content of the duplicate content item 116. Upon loading a view of the web site 108, the browser 103 or browser agent operating with the browser 103 can identify the duplicate content item 116 as being a duplicate of a previously viewed content item since the content identifier is then stored in the content record 122. By comparing content identifiers of content items being loaded from a web site against content identifiers stored in the content record 122, duplicate content items such as duplicate content item 116 can be identified and suppressed when rendering the view of the web site 108 at the browser 103. By “suppressed” it is meant that the duplicate content item is treated as having already been viewed, and that the user of the browser 103 does not wish to see the duplicate content item 116. Hence, in browser 103, the duplicate content item 116 can be undisplayed, minimized, truncated, or otherwise indicated as being a content item that has already been perceived by the user.

In some embodiments the web site (e.g. web site 108) can provide a DOM 126 to be used by the browser 103 in rendering a view of the web site 108. The DOM is created by the web site 108 and is provided to requesting client machines such as computing device 103. The DOM 126 includes a section that indicates filterable content, and lists the content identifiers of content items specified by the DOM which can be filtered (i.e. suppressed) by the rendering browser (e.g. browser 103). The web site 108 can provide content items that a republished or redirected from other sources, such as web site 106. Upon parsing the DOM, the browser 103 can identify the filterable content section of the DOM and compare the content identifier(s) therein to content identifiers in the content record 122 to identify any content items that can be suppressed.

In addition to suppressing duplicative content items, the browser 103 can further suppress links to consumed content items. A link to a previously consumed content item can be considered to be a content item itself when, it is accompanied by information such as, for example, an article title. For example, upon browsing web site 118, which can be a social media website that allows users to post links to content items in their personal feed, the web site 118 can content item 118 which is, or includes, a link (e.g. a URL) to content item 114 on web site 106, which is identified by a content identifier, or by the URL alone. Upon parsing content item 118, the browser 103 can compare the content identifier given for the link in content item 118 to the content record 122 to determine that the content item to which the link refers is a previously consumed content item 114. Upon determining that content item 118 contains the link to the previously consumed content item 114, the browser 103 can suppress the link to avoid or minimize displaying it to the user of the browser 103.

In addition to suppressing previously viewed or duplicate content items, the browser 103 can also prioritize content items that are related to content items that the user of the browser 103 has consumed. For example, after navigating web site 106, the user can navigate to web site 112, which includes content item 120, which is related to content item 114. Content item 120 can include a unique content identifier (e.g. “ibm.com:1265”) and includes an associated content identifier that is the content identifier of content item 114. Upon parsing content item 120 (or any other content item), the browser 103 can identity related content, which can be indicated as being associated with the content item being parsed. The content identifier(s) for related content can be compared to the previously consumed content items and when it is found that the content item being parsed is found to be related to a previously consumed content item it can be prioritized in the view of the web site. To prioritize an associated or related content item, the browser 103 can highlight the rendering of content item 120, move it to a particular position in the browser window or tab, call out the previously consumed content item by title next to the rendering of content item 120, among other ways of drawing the user's attention to it and its relationship to content item 114.

In some embodiments the browser 103 can actively seek out content items that are related to a consumed content item. For example, upon the user of the browser consuming a content item such as content item 116, the browser 103 can determine a root source for the content item, such as based on the content identifier, which can indicate that web site 106 is the root source. After commencing searching for a root source of the consumed content item and finding it at web site 106, for example, the can the search for related content that is related consumed content item at the root source (e.g. web site 106). In addition, the browser can determine at least one more web site that contains the related content (e.g. web site 120), thereby allowing the browser to bring related content to the attention of the user.

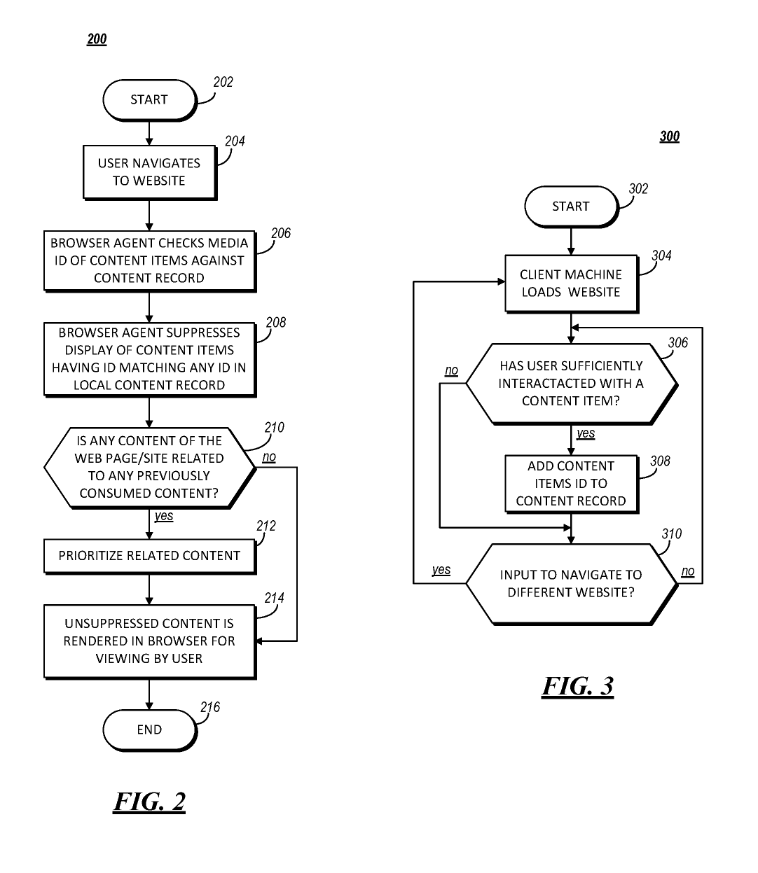

FIG. 2 is a flowchart diagram of a method 200 for suppressing content items previously consumed by a user, and prioritizing related content items when navigating to a new web site, in accordance with some embodiments. At the start 202 the computing device is operational and connected to the Internet, and the browser, along with any browser agent add-on/plug-in, is instantiated and ready for navigational input from a user. In step 204 the user navigates the browser to a selected website, such as by clicking on a hyperlink, selecting a bookmark, or typing in a URL in an address bar. The browser, in response, then connects with the selected website to load the web site view locally. In doing so, the web site provides code and/or a DOM that, among other things, indicates the content items to be rendered in the view. In step 206 the browser compares the indicated content items against the content record to determine if any of the content items provided by the web site have already been consumed by the user. In step 208 the browser renders a view of the web site, and suppresses and content items provided by the web site that have already been consumed by the user. In some embodiments the content or media identifier of the content item can be compared to stored identifiers of content items already consumed. In some embodiments the text of content items can be processed to produce a primitive or an abstraction that can be used in comparisons with similarly derived data structures of candidate content items being evaluated in determining if they are equivalent to previously consumed content items.

In step 210 a determination is made as to whether any content of the web site being loaded is related to any previously consumed content based on the content record maintained at the computing device. Related content can be determined, for example, based on an association expressed by the web site (i.e. in markup or a DOM). Related content can also be determined by other factors, such as having similar common key words, similar authorship, a similar root source, and so on. If any of the content on the web site is related to previously consumed content, then in step 212 the related content can be prioritized in rendering the view of the related content at the computing device. After step 212, or if the web does not contain any content items related to previously consumed content items, then the method commences to step 214 where the unsuppressed content is rendered and any content that has been identified as related to previously consumed content is prioritized in the rendered view of the web site, and the method then terminates in 216.

FIG. 3 is a flow chart diagram of a method 300 for determining when a user has consumed a content item at a client machine, in accordance with some embodiments. The method 300 can be used in the system of FIG. 1 and in conjunction with the method of FIG. 2. At the start 302 the user has the client machine (a computing device) turned on, and a browser is navigated to a media source web site or other web site that provides content items. In step 304 the client machine loads the web site to which the user has navigated. The rendered view of the web site can contain content items that can be interacted with directly and/or links to content items. The method 300 assumes that any previously consumed content items are suppressed, so the content items with which the user can interact are either new content items, or content items related to previously consumed content items. The content items can be identified using, for example, a content identifier that is provided with each content item to uniquely identify the content item. In step 306 a user can commence interaction with a content item such as by clicking a “play” button on a media content item, or clicking on a link to a text-based or mixed media content item. While the content item is capable of being interacted with by the user, the method 300 in step 306 determines if the user has sufficiently interacted with a content item to consider it as having been consumed (e.g. viewed, read, or heard, depending on the content item). Various processes can be used to decide that the user has sufficiently interacted with a content item to consider it consumed, including playing a media file, or playing it for a minimum period of time, scrolling through at least a portion or a minimum portion of a document or web page. If a user sufficiently interacts with a content item, then in step 308 the content identifier of the content item with which the user has interacted is added to a content record for future reference. If the user has not sufficiently interacted with a content item, or after recording the content identifier of a content item with which the user has sufficiently interacted, in step 310 the method 300 can determine if the user has provided navigational input for a different web site, or different page of the present web site. The method can loop back to step 306 if the user has not navigated to a new location, or it can loop back to step 304 to load a new web site or web page and commence another iteration of the method 300.

FIG. 4 is a flow chart diagram of a method 400 for suppressing content items previously consumed by a user, and prioritizing related content items when navigating to a new web site, in accordance with some embodiments. Method 400 can be used in a system such as system 100, and in conjunction with methods 200 & 300. In particular, method 400 applies to embodiments where the web site being loaded provides a DOM that can be sent to a requesting client machine for processing by the client machine. The DOM can be used by the browser at the client machine as a “blueprint” to render a view of the web site in a browser window at the client machine. A section of the DOM can be tagged as indicating filterable content to allow client machines to suppress content included by the web site that the user of the requesting client machine has already consumed, either on the web site, or on other web sites that carry common content.

Accordingly, in step 404 the user of a computing device running a browser application designed in accordance with the embodiments herein can navigate that browser to a web site. In step 406, in parsing the response from the web site, the browser determines whether the web site has provided a DOM that includes a filterable section indicating filterable content of the web site view. If there is, then in step 408 the browser, directly or using a browser agent, compares the identifiers of the content items listed in the filterable section of the DOM against the content identifiers in the local content record indicating the content items previously consumed by the user. In step 410 any matching content identifiers can be flagged or otherwise noted to be suppressed in the rendered view of the web site. The method can then terminate in step 412 by having the browser render a view of the web site in which any previously consumed content items are suppressed.

By allowing the browser to suppress previously consumed content items by keeping a record of consumed content items and then comparing the content items of a new web site to those which have been previously consumed, the user's browsing privacy is protected. A web site cannot determine which content items have already been consumed by the user because that determination is performed at the client machine. Likewise, prioritizing, at the browser, content items that are related to previously consumed content items can be performed exclusively local to the requesting client machine, preventing web sites from determining which content items have been previously consumed by the user.

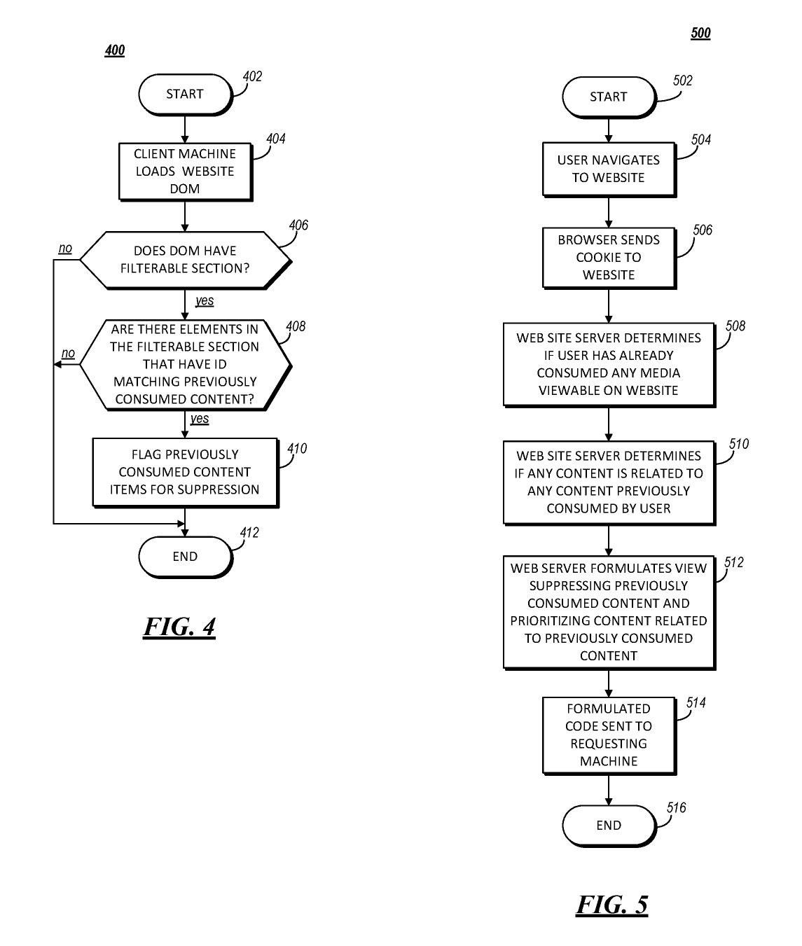

FIG. 5 is a flow chart diagram of a method 500 for suppressing content items previously consumed by a user, and prioritizing related content items when navigating to a new web site, in accordance with some embodiments, and can be used, for example, by the system of FIG. 1. In embodiments represented by the method 500 here, unlike in prior embodiments where the determination of whether a content item provided by a web site is a previously consumed content item or related to a previously consumed content item, the web site makes the determination. In general, in accordance with embodiments represented by the method 500, the browser at the client machine maintains a cookie that can include content identifiers of previously consumed content items.

At the start 502, the browser is instantiated and maintains a cookie that includes the content identifiers of previously consumed content items. In step 504 the user of the client machines provides navigational input to a desired web site, or another section of a presently viewed web site. In response the browser sends a request to the web site in order to load a view of the web site. The request can include the cookie, which gets sent in step 506 to the web site. In step 508 the web site, upon receiving the request and the cookie determines, based on the contents of the cookie, whether any content of the web site has previously been consumed by the user. In steps 510 and 512 the web site (i.e. a server of the web site) receives the request and cookie, and determines if any content it can provide has been either previously consumed or related to content previously consumed by the user, based on the contents of the cookie. In step 512 the web site dynamically formulates markup code for a view of the web site where content items previously consumed by the user are suppressed, and content items related to content items previously consumed by the user are prioritized. In step 514 the web site sends the formulated markup code to the requesting client machine. The method then ends in step 516, where the requesting machine can render the view of the web site in accordance with the markup code as dynamically generated by the web site for the particular requesting client machine.

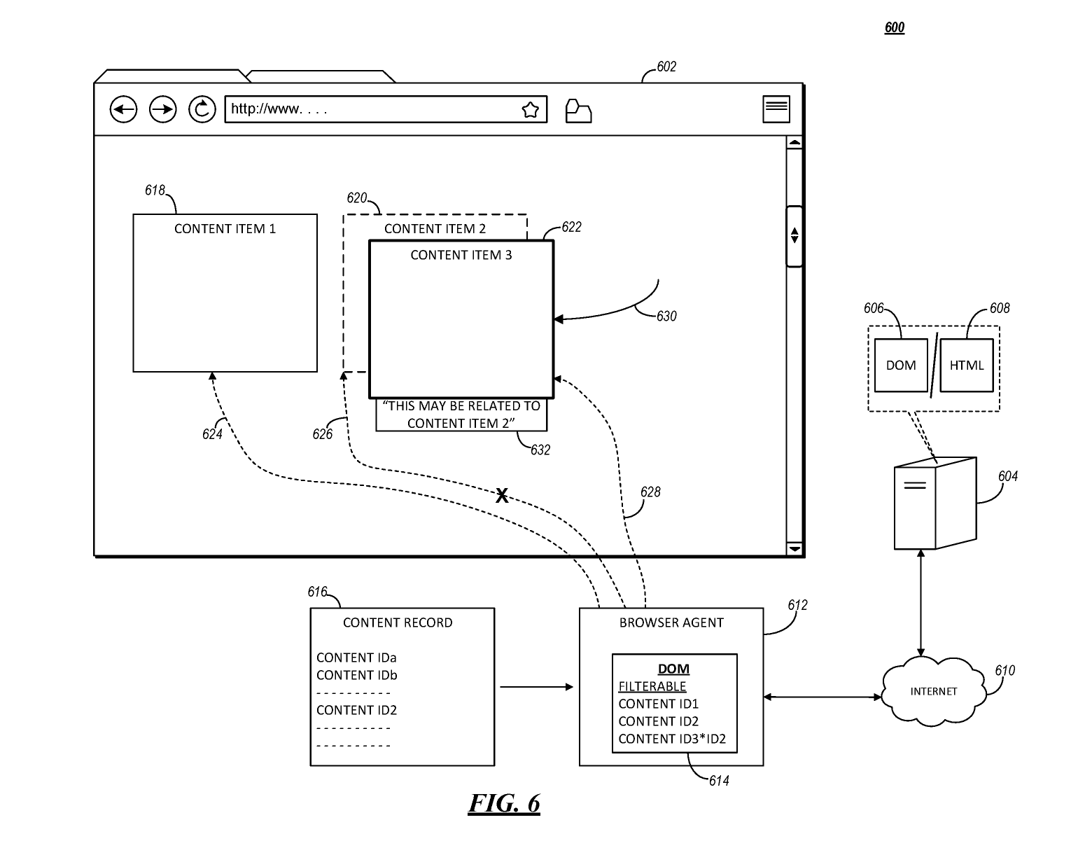

FIG. 6 shows a display 600 of a window 602 of a browser by a computing device in which a previously consumed content item is suppressed and a content item related to a previously consumed content item is prioritized, in accordance with some embodiments. The browser window 602 can include one or more tabs or alternate display areas that can each show a view of a different web site. The browser can work in conjunction with a browser agent 612, which can operate through an application protocol interface (API) of the browser. The user navigates to a web site such as web site 604 via the Internet 610 (or other suitable wide area network). The view of the web site can be specified in a DOM 606 or a markup language such as HTML 608. In some embodiments the view can be dynamically generated based on information provided by the browser, and in other embodiments the web site can simply respond to all requests with the same content, where the browser sorts out which content is to be suppressed and which content is to be prioritized. In some embodiments the browser agent 612 can locally generate a DOM 614 dynamically that is to be rendered by the browser upon receiving a response from the web site 604.

In some embodiments when a response is received from the web site 604, the browser agent 612 can compare the content identifiers of any content items indicated in the response against content identifiers of previously consumed content items stored in a content record 616. As examples consider content items 618, 620, and 622. Content item 618 has a content identifier that is not in the content record 616, so it is rendered 624 for viewing or other interaction in the browser window 602. Content item 620, however, has a content identifier (“CONTENT ID2”) that is in the content record 616, indicating it is a previously consumed content item, and is not rendered 626 (indicated by the “X”). Content item 622 has a content identifier that is also not in the content record 616, there is an indication (e.g. “CONTENT ID3*ID2” where the “*” indicates a relation) that it is related to content item 620, which was previously consumed. Accordingly, the rendering 628 of content item 622 is prioritized by, for example, highlighting 630 or a textual indication 632.

In some embodiments the browser agent 612 can intercept the response from the web site 604 and locally create a DOM 614. In some embodiments the DOM 614 is sent from the web site (i.e. DOM 606 at the web site 604 that becomes DOM 614 at the client machine). In some embodiments the web site 604 dynamically creates a DOM 606 or markup code 608 in response to a cookie received in a request from the client machine which indicates previously consumed content items by identifiers. The content record 616 is maintained locally in the client machine that runs the browser, and can be maintained by the browser agent, as a file accessed by the browser agent 612, or by the browser (e.g. as a cookie). The content items 618, 620, 622, can be rendered as a complete object (e.g. a video), or it can be an anchor using a partially rendered version of a content item that links to the fully rendered version.

In general, the embodiments provide the benefit of eliminating duplicate views of content items with which a user has already interacted, and therefore does not need to see again. Furthermore, they provide the benefit of prioritizing content items that are related to content items previously consumed by the user to draw the user's attention to those items. In some embodiments the web sites will be unable to determine which content items the user has previously consumed since the determination of duplicative content items that can be suppressed is performed at the client machine. In some embodiments the client machine indicates the content items that have been previously consumed by the user of the client machine, and the web site dynamically creates markup code for a rendering a view of the web site in which previously consumed content items are suppressed and which can further prioritize content items that are related to content items that have been previously consumed by the user.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for a client machine to control display of content across a plurality of media source web sites, comprising:
determining consumed content items provided by the media source web sites which are consumed by a user of the client machine during interactions with the plurality of media source web sites, and creating a record of consumed content items;
upon the user interacting with a further media source web site, determining duplicative content items of the further media source web site that are similar to the consumed content items based on the record of consumed content items;
suppressing the duplicative content items from being displayed to the user while interacting with the further media web site;
identifying a related content item of the further media source site that is related to one of the consumed content items; and
prioritizing the related content item for display to the user during interaction with the further media source site.
